(19) United States
(12) Patent Application Publication
(10) Pub. No.: US 2006/0153042 A1
(43) Pub. Date: Jul. 13, 2006

(54) Method for determining optimum recording condition and optical recording/reproducing apparatus using the same

(75) Inventor: Chia-Yen Chang, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On it Corp.

(21) Appl. No.: 11/331,331

(22) Filed: Jan. 11, 2006

(30) Foreign Application Priority Data
Jan. 11, 2005 (TW) 094100772

(51) Int. Cl. G11B 5/09; G11B 7/12

(52) U.S. Cl. 369/59.22; 369/59.23; 369/47.5

(57) ABSTRACT

A method for determining an optimum recording condition of an optical recording/reproducing apparatus is used for recording data into an optical disc. Data is first written into a plurality of test regions of the optical disc under a plurality of recording conditions, respectively. The data written into the plurality of test regions are converted into radio-frequency (RF) signals. The RF signals are Viterbi-decoded to obtain corresponding path metric increase rates. The path metric increase rates are used to determine an optimum recording condition.

### FIELD OF THE INVENTION

The present invention relates to a method for determining an optimum recording condition of an optical recording/reproducing apparatus for recording data in an optical disc, and more particularly to a method for determining the optimum recording condition according to the recorded quality of data. The present invention also relates to an optical recording/reproducing apparatus capable of detecting quality of recorded data and determining an optimum recording condition according to the quality of recorded data.

### BACKGROUND OF THE INVENTION

Referring to FIG. 1, an optical head 1 of an optical recording/reproducing apparatus is schematically shown. A laser beam emitted from a semiconductor laser module 11 is focused on a disc 2 via lenses 14 and 15, and the light reflected by the disc 2 is transmitted to a photo-detector 12 to realize information from the disc 2. In general, data are written into the disc 2 by modifying the recording material of the disc 2 with laser beam to leave distinctive marks in the disc 2. For writing data successfully, power of the laser beam emitted by the semiconductor laser module 11 is generally confined within a critical range. The laser power beyond the operable range would result in inferior data read-back performance or even read-back failure.

Further, depending on the types of discs to be recorded, the laser power applied thereto should be adjusted. For example, the optimum laser power level may vary with the recording material of a disc. Recording data into a CD-R disc and recording data into a CD-RW disc also require different optimum laser power levels. Even the tolerable variation of laser power for recording a regular compact disc (CD) is different from that for recording a digital versatile disc (DVD) due to the difference in data intensity. For adjusting laser power to fit different types of discs, so-called optimum power control or optimum power calibration (OPC) means was developed for recording power test.

The test procedure executed by the OPC means is performed at a specific test area in the disc with different laser power levels of the semiconductor laser module 11 before a real data recording procedure. By measuring and comparing light information reflected by the disc 2 and detected by the photo-detector 12, the optimum laser power level of the semiconductor laser module 11 is determined. The writing process of the optical head 1 of FIG. 1 is illustrated with reference to FIG. 2. When a record command is to be executed (Step 21), a OPC trial recording procedure is first performed so as to determine an optimum recording laser power level (Step 22). Then, a real recording operation is entered to write data with the optimum recording laser power level determined in the OPC trial recording procedure (Step 23).

In prior art, the OPC trial recording procedure determines the optimum recording power level according to quality of the resulting radio frequency (RF) signals. The waveform of FIG. 3 is exemplified to show the quality of a radio frequency (RF) signal represented by a β parameter. As shown, the RF signal is an alternating current signal. The β parameter, which is defined as |(A1−A2)/(A1+A2)|, indicates how a RF signal deviates from a perfect waveform. That is, the symmetric degree of the RF signal relative to a reference voltage is determined in the OPC procedure, and used to indicate the quality of the RF signal. Generally, a reference β value specific to the optical disc is previously recorded in the disc. The detected β values of RF signals corresponding to different power levels are compared with the reference β value, and one of the power levels is determined to be optimum for subsequent data writing operations according to the comparing results.

As mentioned above, a β parameter is used to indicate the quality of the RF signal. The β value, however, cannot perfectly reflect the quality of the RF signal since it just indicates the symmetric degree of the RF signal. Other factors may contribute to the quality of the RF signal. Therefore, more effective parameters need to be referred to for locating the optimum power level.

### SUMMARY OF THE INVENTION

Therefore, the present invention provides a method for determining recording quality of RF signals by referring to other effective parameters.

The present invention also provides a method for determining a recording condition for recording a disc by an optical recording/reproducing apparatus by means of observing the quality of the RF signals, thereby achieving optimum recording performance.

The present invention further provides an optical recording/reproducing apparatus, which is capable of determining recording quality of RF signals and selecting an optimum recording condition by referring to some effective parameters.

In an aspect, the present invention provides a method for determining an optimum recording condition of an optical recording/reproducing apparatus for recording data into an optical disc. In the method, data is written into a plurality of regions of the optical disc under a plurality of recording conditions, respectively. The data written into the plurality of regions are converted into radio-frequency (RF) signals. The RF signals are Viterbi-decoded to obtain corresponding path metric increase rates. An optimum recording condition is determined according to the path metric increase rates.

In an embodiment, the optimum recording condition is selected from the plurality of recording conditions by comparing the path metric increase rates. Preferably, the optimum recording condition is the recording condition resulting in the smallest one of the path metric increase rates. For example, the recording conditions can be power levels used for writing data into the optical disc. For example, the path metric increase rates are increasing rates of correct path metric values or maximum path metric values.

Alternatively, each of the path metric increase rates can be a count of the corresponding path metric value exceeding a threshold within a specified time period in the Viterbi-decoding procedure. The count of the corresponding path metric value exceeding the threshold can be obtained by normalizing the corresponding path metric value exceeding the threshold and calculating the count of the normalizing operation.

In an embodiment, the plurality of regions of the optical disc are located in the test area of the optical disc and the data are test data.

In another aspect, the present invention provides a method for determining recording quality of an optical recording/reproducing apparatus. In the method, a first RF signal and a second RF signal are read from the optical disc. The first RF signal and the second RF signal are Viterbi-decoded to obtain a first path metric increase rate and a second path metric increase rate, respectively. The first path metric increase rate and the second path metric increase rate are compared to determine one of the first and second RF signals resulting in a smaller path metric increase rate to be better in recording quality.

In a further aspect, the present invention provides an optical recording/reproducing apparatus for recording data into an optical disc, e.g. a DVD recorder. The optical recording/reproducing apparatus includes an optical head for writing data into the optical disc and reading and outputting data from the optical disc as an RF signal; and a Viterbi-decoder electrically connected to the optical head for decoding the RF signal to recover the data recorded in the optical disc. The Viterbi-decoder includes a path metric value storage unit and a path metric overflow flag coupled to the path metric value storage unit, and generates a path metric value of the RF signal in a specified Viterbi-decoding procedure. The data subjected to the first Viterbi-decoding procedure is previously recorded into the optical disc under a specified recording condition in a specified data writing procedure, the path metric value of the RF signal is updated and stored in the path metric value storage unit, the path metric overflow flag rises whenever the path metric value stored in the path metric value storage unit exceeds a threshold, and the optical recording/reproducing apparatus determines whether a subsequent data writing procedure is to be performed under the specified recording condition according to a rising count of the path metric overflow flag within a specified time period.

In an embodiment, the specified data writing procedure is a test data writing procedure, and the specified Viterbi-decoding procedure is performed for decoding test data. The optical head sequentially writes test data into a plurality of regions of the optical disc under a plurality of recording conditions and converts the test data into a plurality of radio-frequency (RF) signals, respectively, the Viterbi-decoder sequentially decodes the RF signals, generates and stores path metric values of the plurality of radio-frequency (RF) signals in the path metric value storage unit, and has the path metric overflow flag rise in response to a normalizing operation conducted whenever the path metric values exceed the threshold, and the optical recording/reproducing apparatus determines that a real data writing procedure is to be performed under one of the plurality of recording conditions, which results in the least rising count of the path metric overflow flag within the specified time period.

In an embodiment, the optical recording/reproducing apparatus further includes an RF amplifier electrically connected between the optical head and the Viterbi-decoder for amplifying the RF signal. The Viterbi-decoder further includes a branch metric calculating circuit for calculating branch metrics for the RF signal; an adder-comparator-selector unit electrically connected to the branch metric calculating circuit for performing add-compare-select computations on the branch metrics to obtain the path metric value; and a path memory electrically connected to the adder-comparator-selector unit for storing possible paths of output data.

### BRIEF DESCRIPTION OF THE DRAWINGS

FIG. 1 is a schematic diagram illustrating a typical optical head of a disc recording apparatus;

FIG. 2 is a flowchart illustrating the writing process of the optical head of FIG. 1;

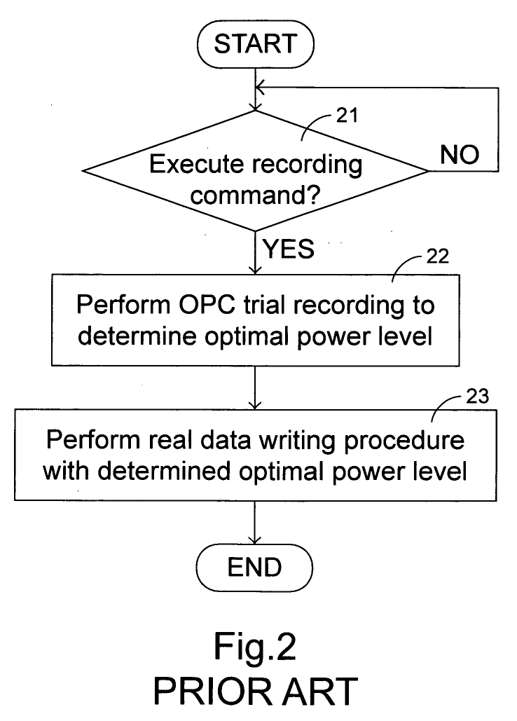

FIG. 3 is a schematic waveform diagram illustrating the asymmetric degree of an RF signal;

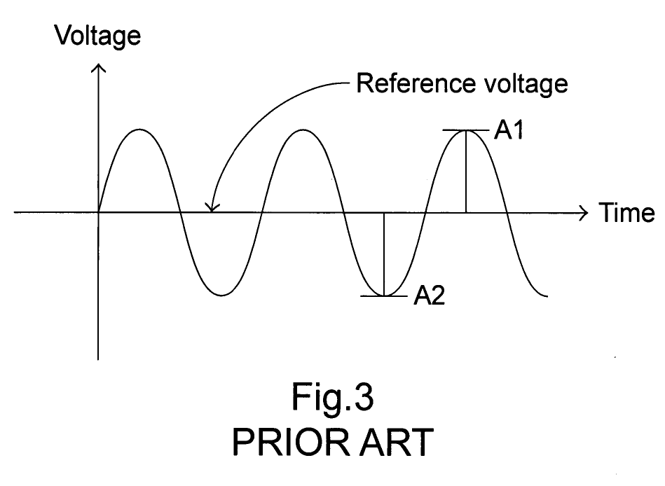

FIG. 4 is a block diagram illustrating an optical recording/reproducing apparatus according to an embodiment of the present invention, which is capable of detecting quality of recorded data and determining an optimum recording condition according to the quality of recorded data; and

FIG. 5 is a flowchart illustrating a method for determining an optimum recording condition according to an embodiment of the present invention.

### DETAILED DESCRIPTION OF THE PREFERRED EMBODIMENT

According to the present invention, a path metric value generated in a Viterbi-decoding procedure is used as a parameter for an optical recording/reproducing apparatus to determine the quality of recorded data.

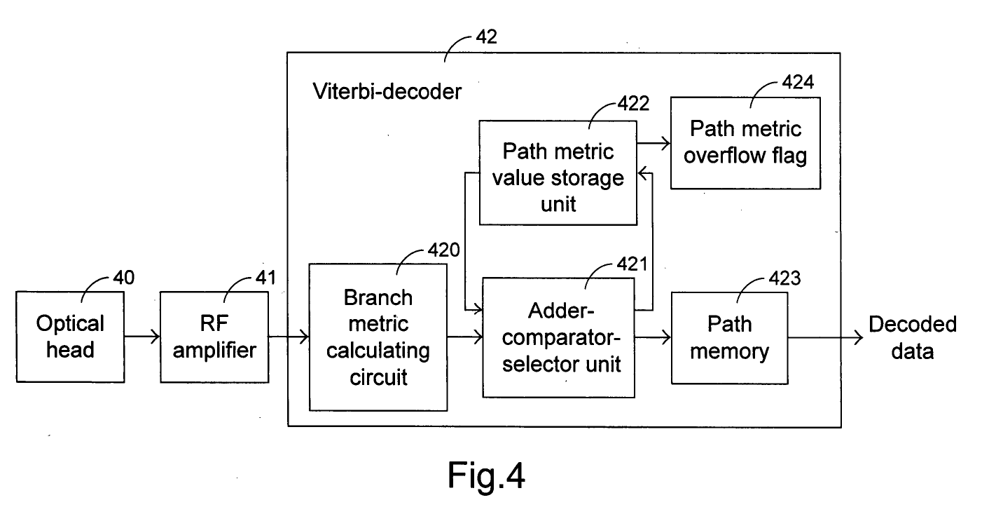

Referring to FIG. 4, the optical recording/reproducing apparatus includes an optical head 40, a radio frequency (RF) amplifier 41 and a Viterbi-decoder 42 for reading and/or recording data. The optical head 40 is used for writing data into an optical disc and reading data from an optical disc. The data read by the optical head 40 is converted and outputted as an RF signal. The RF signal is amplified by the RF amplifier 41 before entering the Viterbi-decoder 42 to be decoded. The Viterbi-decoder 42 is electrically connected to the optical head 40 for decoding the RF signal to recover the data recorded in the optical disc. The Viterbi-decoder 42 includes a branch metric calculating circuit 420, an adder-comparator-selector unit 421, a path metric value storage unit 422, and a path memory 423. The path metric overflow flag 424 is coupled to the path metric value storage unit 422. When the RF signal is inputted into the Viterbi-decoder 42, the branch metric calculating circuit 420 calculates branch metrics for the RF signal, and the adder-comparator-selector unit 421 electrically connected to the branch metric calculating circuit 420 performs add-compare-select computations on the branch metrics to obtain a path metric value. The path metric value is updated and stored in the path metric value storage unit 422, which is a register. The path memory 423 stores a plurality of possible output-data paths, and outputted the decoded data according to the path metric value, which is the minimum one stored in the path metric value storage unit 422 and outputted by the adder-comparator-selector unit 421.

As those skilled in the art know, the correct path metric value will be zero and the maximum path metric value will remain constant if there is no interfering noise. However, in practice, both the correct path metric value and maximum metric value will accumulatively increase. For an RF signal involving significant path metric increase, the quality of the RF signal will be considered not good. Accordingly, by monitoring the correct path metric increase rate or maximum path metric increase rate, or both, the quality of the RF signal can be determined. That is, when the correct or maximum path metric increase rate of a first RF signal is smaller than that of a second RF signal, the first RF signal will be determined to be better than the second RF signal in recording quality.

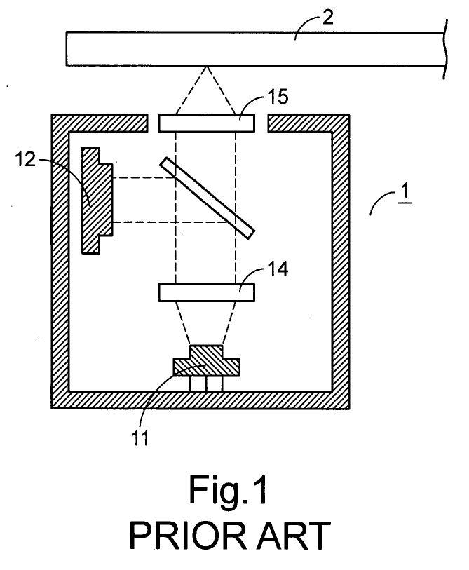

The above-mentioned quality-determining method is particularly useful for determining an optimum recording condition for a real data writing procedure. As described with reference to FIG. 1, for writing data successfully, recording conditions such as the power level of the laser beam emitted by the semiconductor laser module 11 need to be optimized. Thus a test data writing procedure is performed before a real data writing procedure. In the test data writing procedure, various recording conditions are used for writing test data into the optical disc, and then the test data are read out to be compared so as to determine which recording condition results in the most satisfactory recording quality.

According to an embodiment of the present invention, the correct or maximum path metric increase rates of a plurality of RF signals resulting from the test data recorded in different test regions of the optical disc are detected. By comparing the path metric increase rates, the recoding condition resulting in the smallest path metric increase rate is determined to be the optimum recording condition for the optical disc. Therefore, that recording condition is used for subsequent real data writing procedure.

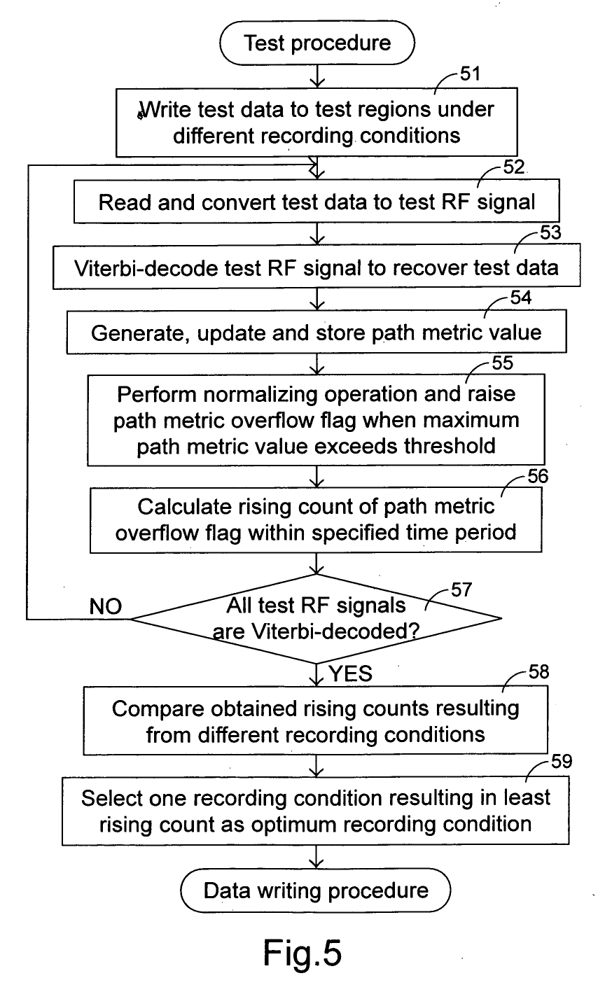

In another embodiment, the path metric increase rate is reasonably expressed by the overflow frequency of the path metric value storage unit 422 (FIG. 4). In this embodiment, the Viterbi-decoder further includes a path metric overflow flag 424 coupled to the path metric value storage unit 422. The writing process of an optical recording/reproducing apparatus, which for example can be a DVD decoder, will be described herein with reference to the flowchart of FIG. 5. First of all, a test procedure is executed by writing test data to a plurality of test regions of the optical disc to be recorded under different recording conditions, e.g. different power levels (Step 51). The recorded test data is read out and converted into an RF signal (Step 52) which is then Viterbi-decoded to recover the test data (Step 53). Meanwhile, a path metric value is generated, updated and stored in the path metric value storage unit 422 during the Viterbi-decoding operation (Step 54). A normalizing operation which downward shifts the path metric value by subtracting a constant whenever the maximum path metric value exceeds a threshold that indicates the overflowing of the path metric value storage unit 422 (Step 55). The path metric overflow flag 424 rises whenever the normalizing operation is performed. The rising count of the path metric overflow flag 424 will be used to represent the path metric increase rate (Step 56). After all rising counts are calculated (Step 57), the rising counts of the path metric overflow flag 424 corresponding to the RF signals resulting from the plurality of recording conditions within a specified time period are compared (Step 58). The recording condition that results in least rising count of the path metric overflow flag 424 will be the optimum recording condition for subsequent real data writing procedure (Step 59).

It is understood from the above description that the path metric increase rate for determining recording quality of data can be achieved by monitoring the rising path metric overflow flag. According to the recording quality of data of all the test RF signals, the optimum recording condition specific to that optical disc can be determined or selected, thereby improving the data writing quality of the optical recording/reproducing apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining an optimum recording condition of an optical recording/reproducing apparatus for recording data into an optical disc, comprising steps of:
writing data into a plurality of regions of the optical disc under a plurality of recording conditions, respectively;
converting said data written into said plurality of regions into radio-frequency (RF) signals;
Viterbi-decoding said RF signals to obtain corresponding path metric increase rates; and
determining an optimum recording condition according to said path metric increase rates.

2. The method according to claim 1 wherein said optimum recording condition is selected from said plurality of recording conditions by comparing said path metric increase rates.

3. The method according to claim 1 wherein said optimum recording condition is the recording condition resulting in the smallest one of said path metric increase rates.

4. The method according to claim 1 wherein said recording conditions are power levels used for writing data into the optical disc.

5. The method according to claim 1 wherein said path metric increase rates are increasing rates of correct path metric values.

6. The method according to claim 1 wherein said path metric increase rates are increasing rates of maximum path metric values.

7. The method according to claim 1 wherein each of said path metric increase rates is a count of the corresponding path metric value exceeding a threshold within a specified time period in the Viterbi-decoding procedure.

8. The method according to claim 7 wherein said count of the corresponding path metric value exceeding said threshold is obtained by normalizing the corresponding path metric value exceeding said threshold and calculating the count of the normalizing operation.

9. The method according to claim 1 wherein said plurality of regions of the optical disc are located in the test area of the optical disc and said data are test data.

10. A method for determining recording quality of an optical recording/reproducing apparatus, comprising steps of:
reading a first RF signal and a second RF signal from the optical disc;
Viterbi-decoding said first RF signal and said second RF signal to obtain a first path metric increase rate and a second path metric increase rate, respectively; and
comparing said first path metric increase rate and said second path metric increase rate and determining one of said first and second RF signals resulting in a smaller path metric increase rate to be better in recording quality.

11. The method according to claim 10 wherein said path metric increase rates are increasing rates of correct path metric values.

12. The method according to claim 10 wherein said path metric increase rates are increasing rates of maximum path metric values.

13. The method according to claim 10 wherein each of said path metric increase rates is a count of the corresponding path metric value exceeding a threshold within a specified time period in the Viterbi-decoding procedure.

14. The method according to claim 13 wherein said count of the corresponding path metric values exceeding said threshold is obtained by normalizing the corresponding path metric value exceeding said threshold and calculating the count of the normalizing operation.

15. An optical recording/reproducing apparatus for recording data into an optical disc, comprising:
an optical head for writing data into the optical disc and reading and outputting data from the optical disc as an RF signal; and
a Viterbi-decoder electrically connected to said optical head for decoding said RF signal to recover said data recorded in the optical disc, said Viterbi-decoder comprising a path metric value storage unit and a path metric overflow flag coupled to said path metric value storage unit, and generating a path metric value of said RF signal in a specified Viterbi-decoding procedure,
wherein said data subjected to said specified Viterbi-decoding procedure is previously recorded into the optical disc under a specified recording condition in a specified data writing procedure, said path metric value of said RF signal is updated and stored in said path metric value storage unit, said path metric overflow flag rises whenever said path metric value stored in said path metric value storage unit exceeds a threshold, and said optical recording/reproducing apparatus determines whether a subsequent data writing procedure is to be performed under said specified recording condition according to a rising count of said path metric overflow flag within a specified time period.

16. The optical recording/reproducing apparatus according to claim 15 wherein said specified data writing procedure is a test data writing procedure, and said specified Viterbi-decoding procedure is performed for decoding test data recorded in the optical disc.

17. The optical recording/reproducing apparatus according to claim 16 wherein said optical head sequentially writes test data into a plurality of regions of the optical disc under a plurality of recording conditions and converts said test data into a plurality of radio-frequency (RF) signals, respectively, said Viterbi-decoder sequentially decodes said RF signals, generates and stores path metric values of said plurality of radio-frequency (RF) signals in said path metric value storage unit, and has said path metric overflow flag rise in response to a normalizing operation conducted whenever said path metric values exceed said threshold, and said optical recording/reproducing apparatus determines that a real data writing procedure is to be performed under one of said plurality of recording conditions, which results in the least rising count of said path metric overflow flag within said specified time period.

18. The optical recording/reproducing apparatus according to claim 15 being a DVD recorder.

19. The optical recording/reproducing apparatus according to claim 15 further comprising an RF amplifier electrically connected between said optical head and said Viterbi-decoder for amplifying said RF signal.

20. The optical recording/reproducing apparatus according to claim 15 wherein said Viterbi-decoder comprises:
a branch metric calculating circuit for calculating branch metrics for said RF signal;
an adder-comparator-selector unit electrically connected to said branch metric calculating circuit for performing add-compare-select computations on said branch metrics to obtain said path metric value; and
a path memory electrically connected to said adder-comparator-selector unit for storing possible paths of output data.
